(19) United States
(12) Patent Application Publication
(10) Pub. No.: US 2018/0266939 A1
(43) Pub. Date: Sep. 20, 2018

(54) METHOD AND DEVICE FOR DETERMINING A SUBSTANCE CONCENTRATION OR A SUBSTANCE IN A LIQUID MEDIUM

(71) Applicant: SWAN ANALYTISCHE INSTRUMENTE AG, Hinwil (CH)

(72) Inventor: Heinz WAGNER, Zürich (CH)

(73) Assignee: SWAN ANALYTISCHE INSTRUMENTE AG, Hinwil (CH)

(21) Appl. No.: 15/755,495

(22) PCT Filed: Jul. 6, 2016
(86) PCT No.: PCT/EP2016/065900

§ 371 Date: Feb. 26, 2018

(30) Foreign Application Priority Data
Aug. 27, 2015 (EP) 15182702.9
Oct. 23, 2015 (EP) 15191297.9

(51) Int. Cl. G01N 21/17; G01N 21/3577; G01N 21/27

(52) U.S. Cl. CPC G01N 21/1717; G01N 21/3577; G01N 21/0303; G01N 2021/1723; G01N 2201/129; G01N 21/274

(57) ABSTRACT

Method and device for determining at least one substance concentration (c) or at least one substance in a liquid medium, wherein the method consists of the following steps,
liquid medium is introduced at a predefined flow speed into a vessel having a known shape,
electromagnetic waves having predefined wavelength or having predefined wavelength range are coupled into the liquid medium contained in the vessel, wherein the electromagnetic waves cover a path length in the liquid medium which is dependent on a fill level (xᵢ) of the liquid medium in the vessel,
intensities (Φᵢ) of the electromagnetic waves are measured after covering the path length in the liquid medium at at least two predefined points in time (tᵢ) and/or at at least two predefined fill levels (xᵢ) of the vessel, and
   after a last intensity measurement, the at least one substance concentration (c) or the at least one substance is determined using the measured intensities (Φᵢ) and the at least two predefined points in time (tᵢ) or the at least two predefined fill levels (xᵢ), respectively.

The present invention relates to a method for determining at least one substance concentration or at least one substance in a liquid medium and also a device for this purpose according to the preamble of claim 10.

Spectroscopic analysis is a broad field, in which the composition and the properties of a substance in any phase—gas, liquid, solid—are determined by the electromagnetic spectra which result from the interaction (for example, absorption, luminescence, or emission) with energy.

One area of application, in particular known as absorption spectroscopy, comprises the measurement of optical absorption spectra of liquid substances. An absorption spectrum is the distribution of the light damping (by absorption) as a function of the light wavelength. The fundamental structure of a spectrophotometer is that the substance to be studied is provided in a transparent vessel—also referred to, for example, as a cuvette or sample cell. Electromagnetic beams (light) of a known wavelength A (for example, in the ultraviolet, infrared, visible, etc. range) and the intensity I are coupled into the vessel. A measuring unit or a detector, which measures the intensity of the exiting light, is arranged on the opposing side of the vessel. In this case, the length which the light covers in the sample is referred to as the path length or distance d.

In most spectrophotometers, standardized cuvettes are used, which have a path length of 1 cm and a capacity of 50 to 2000 μl.

For a sample which consists of a single homogeneous substance having a concentration c, the law of Lambert, Beer, and Bouguer applies to the light transmitted through the sample:

$$A = ln ( \frac{{Φ}_{0}}{{Φ}_{tr}} ) = ɛ \cdot c \cdot d$$

In this case, A is the extinction (or absorption), Φₜᵣ is the intensity after the transmission, Φ₀ is the initial intensity, ε is the coefficient of extinction (which is generally constant at a predefined wavelength λ), c is the concentration, and d is the path length. For further specifications on the foundations of spectrophotometry and the terms and definitions used in this case, reference is made to the norm DIN 38404-3 (version of July 2005).

If multiple substances are contained in the sample, a total absorption Aₜₒₜ results as follows:

$${A}_{tot} = ( {\sum }_{j} {ɛ}_{j} ( λ ) \cdot {c}_{j} ) \cdot d$$

The laws briefly explained above also apply in particular in the monitoring of water quality, which is progressively performed repeatedly. As described in DIN 38404-3, the determination is performed at a wavelength λ=254 nm, possibly also additionally at λ=550 nm.

It has been shown in known devices that with so-called online monitoring, in which running and repeated determination of the water quality is performed using the same measuring instrument, as a result of soiling of the cuvette window, through which the electromagnetic waves are coupled in, a drift of the instrument zero point results, whereby measuring errors arise. The zero point can be redetermined at regular intervals by using a calibration liquid (for example, optically pure water according to DIN ISO 3696, 7.4) having known absorption for a measurement.

Another possibility for counteracting the problem of contamination is to use a so-called two-beam photometer, in which, in addition to the measuring channel, a reference channel, preferably having optically pure water, is used, wherein it is assumed that both channels are equally soiled and therefore the drift is equal. In this regard, reference is made to an article having the title “Drinking Water and Open Waters Application Sheet, V 2.0” (S::can Messtechnik GmbH, Vienna, page 5, chapter 4 under “Long-term stability”).

Finally, mechanical cleaning of the cuvette using a wiper or using compressed air has been proposed. In this regard, reference is also made to the above-mentioned article, specifically on page 5, chapter 3, under “Lower cross-sensitivity on turbidity, coloration, window deposit, etc.” and to the article having the title “UVAS plus sc—Die kontinuierliche Bestimmung der organischen Abwasserbelastung [the continuous determination of the organic wastewater load]” (page 2, chapter “Messprinzip [measuring principle]”, Hach Lange GmbH).

The known instruments have the disadvantage that the efficiency of the cleaning can be estimated only with difficulty or not at all, or a calibration results in interruptions in the monitoring. All known methods share the feature that they are relatively complex and thus costly to implement.

It is therefore the object of the present invention to specify a method which at least does not have one of the above-mentioned disadvantages.

The method claimed in claim 1 achieves the above-mentioned object. Further embodiment variants and a device are specified in further claims.

The present invention firstly relates to a method for determining at least one substance concentration or at least one substance in a liquid medium, wherein the method consists of the following steps,
liquid medium is introduced at a predefined flow speed into a vessel having a known shape,
electromagnetic waves having predefined wavelength and/or having predefined wavelength range are coupled into the liquid medium contained in the vessel, wherein the electromagnetic waves cover a path length in the liquid medium which is dependent on the fill level of the liquid medium in the vessel,
intensities of the electromagnetic waves are measured after covering the path length in the liquid medium at at least two predefined points in time and/or at at least two predefined fill levels of the vessel, and
after a last intensity measurement, the at least one substance concentration or the at least one substance, respectively, is determined using the measured intensities and the at least two predefined points in time and/or the at least two predefined fill levels.

By performing at least two intensity measurements at different fill levels of liquid medium in the vessel, a possible zero point drift, which can arise, for example, due to soiling of the vessel, has no influence on the accuracy of the obtained concentration. Cleaning of the vessel or calibration by means of a separate measuring channel or a measurement using optically pure water can be completely dispensed with. A much more robust and interference-resistant measuring instrument has thus been obtained.

One embodiment variant of the method according to the invention comprises the following further steps,
n intensities are measured at n fill levels, wherein the n fill levels are preferably selected as equidistant, and
substance concentrations are determined according to the following formula:

$${c}_{i} = \frac{ln {Φ}_{i} ( {x}_{i} ) - ln {Φ}_{i - 1} ( {x}_{i - 1} )}{- 2.302 * ɛ * ( {x}_{i} - {x}_{i - 1} )}$$

wherein cᵢ is the i-th substance concentration, xᵢ is the i-th fill level, Φᵢ(xᵢ) is a measured i-th intensity at a fill level xᵢ, i is the index, which extends in integers from 1 to n, and ε is the coefficient of extinction, and wherein n has a value in the range of 1 to several hundred, preferably a value in the range of 10 to 100.

Further embodiment variants of the method according to the invention comprise the following further steps,
a first fill level is detected, at which a first intensity is measured,
a last fill level is detected, at which a last intensity is measured,
   wherein the detection of the first fill level and/or the last fill level is preferably performed using a light barrier.

Further embodiment variants of the method according to the invention comprise the step that the substance concentration c is computed either by averaging from the n substance concentrations cᵢ where i=0 . . . n or by means of linear regression, in particular by means of simple linear regression.

In further embodiment variants of the method according to the invention, the flow speed of the liquid medium is constant.

In further embodiment variants of the method according to the invention, the vessel is a cuvette, the longitudinal axis of which extend substantially vertically, and which has a constant cross-sectional area, wherein the electromagnetic waves are preferably coupled into the cuvette from below and the intensity is preferably measured above the cuvette.

Further embodiment variants of the method according to the invention comprise the following further steps,
the vessel is automatically emptied after the last intensity measurement and
after completed emptying, the vessel is automatically filled using new liquid medium for a new measuring cycle.

Further embodiment variants of the method according to the invention comprise the step that the fill levels are ascertained via a time measurement.

Further embodiment variants of the method according to the invention comprise the step that the fill levels are ascertained via the absorption of a solvent, at a wavelength where only the solvent and not the dissolved substances absorb.

In further embodiment variants of the method according to the invention, the electromagnetic waves have a wavelength of 254 nm or 550 nm.

Furthermore, the invention relates to a device for determining a substance concentration and/or at least one substance in a liquid medium, wherein the device comprises:
a vessel having a known shape,
a source for generating electromagnetic waves,
a measuring unit for measuring electromagnetic waves, and
a connecting channel, via which an inflow and outflow of liquid medium into or out of, respectively, the vessel is controllable,
the source can emit electromagnetic waves into the vessel, so that the electromagnetic waves cover a path length in the liquid medium which is dependent on a fill level of the liquid medium in the vessel,
intensities of the electromagnetic waves after covering the path length in the liquid medium are measurable using the measuring unit at at least two predefined points in time and/or at at least two predefined fill levels of the vessel, and
the substance concentration or the at least one substance is determinable using a computer unit based on the measured intensities and the at least two predefined points in time and/or the at least two predefined fill levels.

One embodiment variant of the device according to the invention is distinguished in that,
n intensities are measurable at n fill levels, wherein the n fill levels are preferably selected as equidistant, and
substance concentrations are determinable in the computer unit according to the following formula:

$${c}_{i} = \frac{ln {Φ}_{i} ( {x}_{i} ) - ln {Φ}_{i - 1} ( {x}_{i - 1} )}{- 2.302 * ɛ * ( {x}_{i} - {x}_{i - 1} )}$$

wherein cᵢ is the i-th substance concentration, xᵢ is the i-th fill level, Φᵢ(xᵢ) is a measured i-th intensity at a fill level xᵢ, i is the index, which extends in integers from 1 to n, and ε is the coefficient of extinction, and wherein n has a value in the range of 1 to several hundred, preferably a value in the range of 10 to 100.

Further embodiment variants of the device according to the invention are that,
a first fill level is detectable, at which a first intensity is measurable,
a last fill level is detectable, at which a last intensity is measurable,
   wherein preferably a first light barrier or a second light barrier, respectively, is provided for detecting the first fill level and the last fill level.

Further embodiment variants of the device according to the invention are that the substance concentration c is computable in the computer unit either by averaging from the n substance concentrations cᵢ where i=1 . . . n or by means of linear regression, in particular by means of simple linear regression.

Further embodiment variants of the device according to the invention are that a conveyor device is provided, which is operationally connected to the connecting channel, wherein the conveyor device preferably conveys liquid medium at constant flow speed into the vessel.

Further embodiment variants of the device according to the invention are that the conveyor device for filling and emptying the vessel comprises an automatically actuable switching valve.

Still further embodiment variants of the device according to the invention are that the vessel is a cuvette, the longitudinal axis of which extends essentially vertically, and which has a constant cross-sectional area, wherein the electromagnetic waves are preferably coupled from below into the cuvette and the intensity is preferably measured above the cuvette.

Further embodiment variants of the device according to the invention are that the vessel is arranged inverted in the sense of an immersion probe, wherein a fill level in the vessel is settable by means of air displacement.

Further embodiment variants of the device according to the invention are that electromagnetic waves having wavelengths of 254 nm and 550 nm can be generated using the source.

Further embodiment variants of the device according to the invention are that a viewing tube has a communicative connection to the vessel, via which at least the first fill level and the last fill level are determinable.

It is expressly noted that the above embodiment variants are combinable as desired. Only the combinations of embodiment variants which would result in a contradiction due to combination are excluded.

Exemplary embodiments of the present invention will be explained in greater detail hereafter on the basis of figures. In the figures:

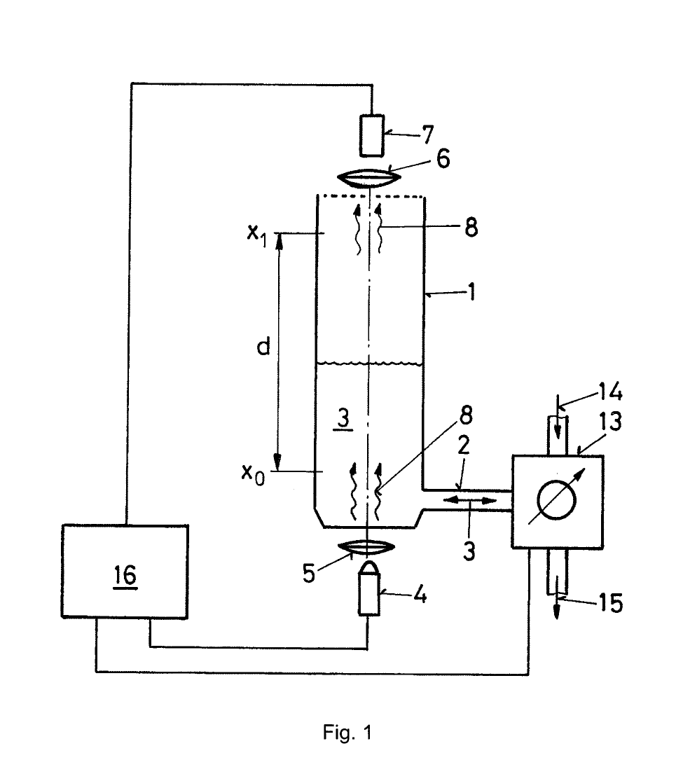

FIG. 1 shows a first embodiment variant of a device according to the invention,

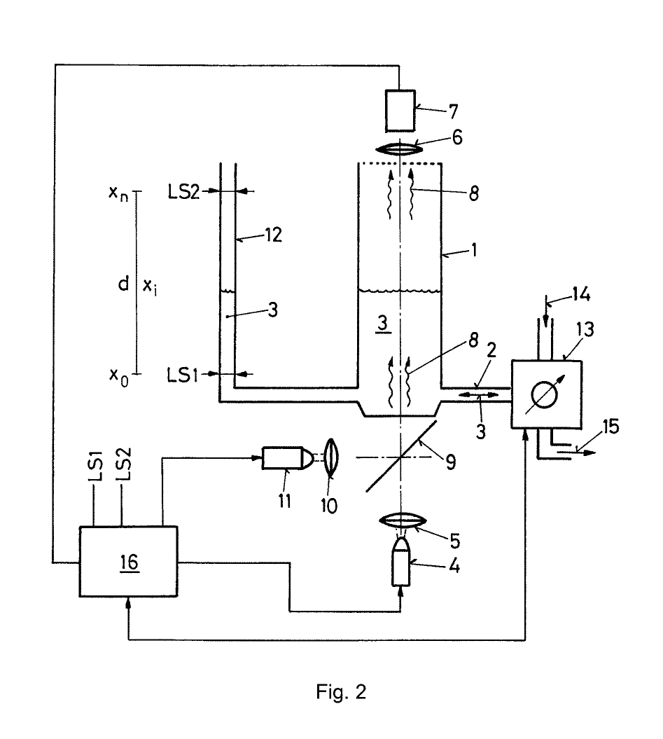

FIG. 2 shows a second embodiment variant of a device according to the invention,

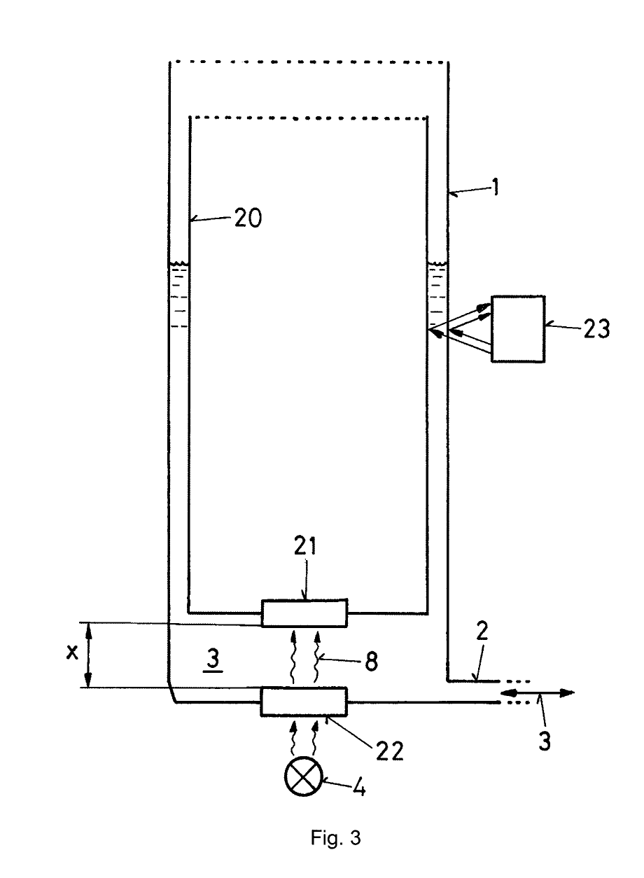

FIG. 3 shows a third embodiment variant of a device according to the invention,

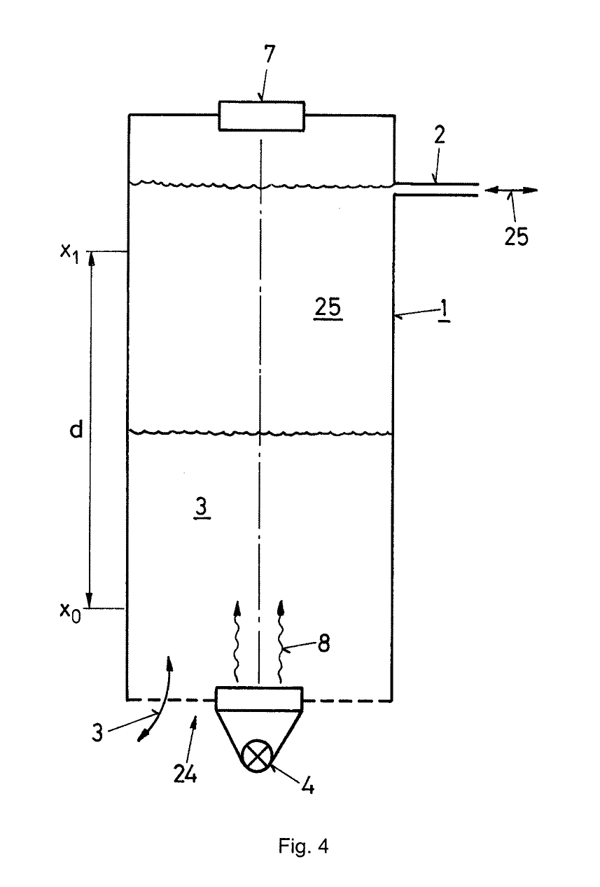

FIG. 4 shows a fourth embodiment variant of a device according to the invention, and

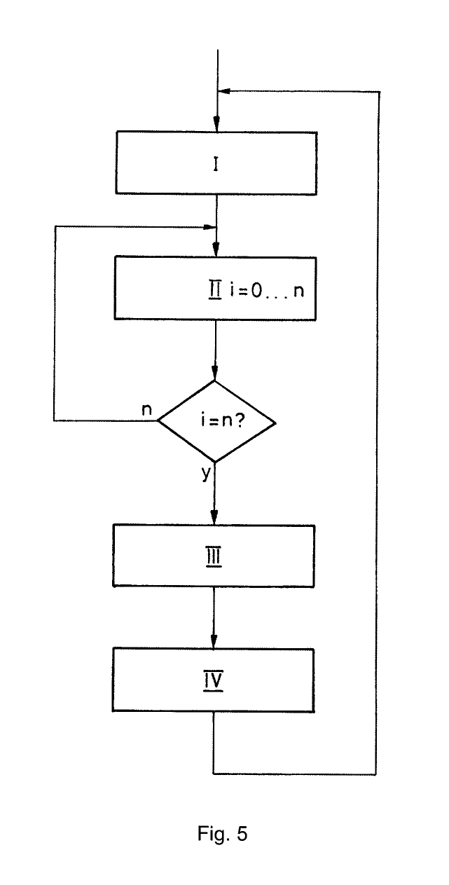

FIG. 5 shows a flow chart having individual method steps of the method according to the invention.

A first embodiment variant of the device according to the invention is schematically illustrated in FIG. 1. A vessel 1 having known shape is filled using a liquid medium 3 to be studied via a connecting channel 2, which connects the vessel 1 to a conveyor device 13. The conveyor device 13 can be implemented in any arbitrary manner, but fulfills the following functions:
Generating a predetermined flow speed for the liquid medium 3 flowing into the vessel 1, wherein the flow speed is constant in one embodiment variant of the invention.
The option of being able to empty the vessel 1 in turn after a measurement to be explained hereafter.

The mentioned functions do not necessarily have to be implemented in one unit—the conveyor device 13 according to FIG. 1—but rather can also be implemented in multiple units.

The predetermined flow speed is generated, for example, using a metering pump (for example, in the form of a displacement pump, in particular a gearwheel pump) or using a vessel having constant sample level (constant head) and using a capillary as a sample drain into the cuvette.

A source 4 for generating electromagnetic waves 8 (light) is arranged below the vessel 1, for example, so that the electromagnetic waves 8 are coupled into the vessel 1 such that a path length covered by these electromagnetic waves is dependent on a fill level of liquid medium 3 in the vessel 1. Accordingly, the electromagnetic waves 8 run from below (as shown in FIG. 1) or from above through the liquid medium 3 contained in the vessel 1 until the remaining intensity of the electromagnetic waves 8 emitted by the source 4 is measured by a measuring unit 7. Accordingly, the measuring unit 7 is arranged in the beam course of the electromagnetic waves 8 emitted by the source 4 opposite to the source 7, so that the measuring unit 7 can ascertain the intensity of the electromagnetic waves 8 after the penetration of the liquid medium 3 contained in the vessel 1.

Lenses or lens systems 5 and 6 can be provided to bundle the electromagnetic waves 8 emitted by the source 4 and to concentrate the electromagnetic waves after the penetration of the liquid medium 3 contained in the vessel 1. The efficiency is thus increased by better light yield.

The source 4, the measuring unit 7, and the conveyor device 13 are operationally connected to a computer unit 16, whereby a control of the device according to the invention can be performed according to a sequence to be explained hereafter.

The vessel 1—as is apparent in FIG. 1—can be a cuvette, for example, which has a transparent window at least in the bottom region, through which the electromagnetic waves of the source 4 can reach the liquid medium 3.

The electromagnetic waves 8 emitted by the source 4 have, for example, a wavelength λ of 254 nm or of 550 nm according to the above-mentioned norm DIN 38404-3 (July 2005). Depending on an absorption maximum, which is dependent on the ingredients to be detected, the wavelength can be selected arbitrarily. Accordingly, wavelengths other than the above-mentioned wavelengths are entirely conceivable.

In particular, it is also conceivable that—as indicated above—the electromagnetic waves 8 emitted by the source 4 cover a predefined spectrum, therefore a predefined wavelength range, and not only one or possibly two wavelengths, as is provided according to DIN 38404-3. At the same time, the measuring unit 7 has to be designed so that intensities can be ascertained and/or measured at multiple frequencies, therefore also in a predefined spectrum and/or wavelength range. The possibility is thus also provided of being able to determine the substances present and the proportions thereof in the liquid medium 3 in the meaning of the known method and/or device according to EP-0 600 334 B1. Corresponding to EP-0 600 334 B1, an array of measuring channels is provided, the results of which are processed accordingly in the computer unit 16.

FIG. 2 shows a further embodiment of the device according to the invention for determining at least one substance concentration or at least one substance in a liquid medium 3. The components which are already illustrated in FIG. 1 and are provided with the same reference signs as therein are again recognizable. These are the vessel 1, the connecting channel 2, the conveyor device 13, the source 4 for electromagnetic waves 8, the measuring unit 7, the computer unit 16, and the lenses or lens systems 5 and/or 6 after the source 4 and/or before the measuring unit 7.

In the embodiment variant shown in FIG. 2, a viewing tube 12 is additionally provided, which is connected to the vessel 1 via a further connecting channel, so that the fill level in the viewing tube 12 corresponds to that in the vessel 1. The possibility is therefore provided that the fill level can be ascertained, for example, using light barriers LS1 and LS2, at the location of the light barriers LS1, LS2.

Furthermore, a partially transmissive transmission unit 9 (for example, in the form of a partially transmissive mirror) is provided in the region of the source 4, which transmits the electromagnetic waves of the source 4 in the direction of the measuring unit 7, but also deflects the electromagnetic waves generated by a further source 11 in the direction of the measuring unit 7. Therefore, the sources 4 and 11 can generate electromagnetic waves having different wavelengths λ and can couple them simultaneously or offset in time into the liquid medium 3 in the vessel 1. Based on the requirement of norm DIN 38404-3 (version July 2015), for example, the source 4 can generate electromagnetic waves having a wavelength λ of 254 nm and the source 11 can generate electromagnetic waves having a wavelength λ of 550 nm. A compact instrument is therefore obtained, which enables a targeted measurement of the residual intensities at two different wavelengths λ.

As already in the case of the source 4, a lens or a lens system 10 is also connected downstream in the case of the further source 11, so that a maximum light yield can be achieved during a measuring procedure. Furthermore, the further source 11 is also operationally connected to the computer unit 16 for activation. This also applies to the light barriers LS1 and LS2, the detection signal of which is also supplied to the computer unit 16 for further processing.

Of course, it is also conceivable in this embodiment that the sources 4 and 11 can emit a predefined wavelength range as defined in EP-0 600 334 B1, to be able to ascertain the substances and/or substance concentrations provided in the liquid medium 3—again according to the teaching of EP-0 600334 B1.

FIG. 3 shows a further embodiment variant of the device according to the invention, wherein in FIG. 3, the vessel 1, the connecting channel 2, and the source 4 are again shown. In addition to the embodiment variant shown in FIGS. 1 and 2, the embodiment variant shown in FIG. 3 comprises, in the vessel 1, a container 20, which contains an exit window 21 for the electromagnetic waves 8 in its bottom region. The exit window 21 lies opposite to an entry window 22 incorporated into the vessel 1, through which the electromagnetic waves 8 generated in the source 4 are coupled into the liquid medium 3. It is also conceivable that the source 4 is not arranged below the vessel 1 as shown in FIG. 3, but rather in the container 20 and therefore above the window 21. The measuring unit (not shown in FIG. 3) would then accordingly be arranged below the window 22.

The embodiment variant of the present invention shown in FIG. 3 is suitable in particular if, because of highly absorbent substances in the liquid medium 3, only relatively small distances x or distance changes are possible between the entry window 22 and the exit window 21. This is the case, for example, with nitrate-containing liquid media. Therefore, the supply and/or removal of liquid medium 3 can in particular be performed using the same metering units as in the embodiment variants according to FIGS. 1 and 2 via the connecting channel 2.

Furthermore, the distance x between the two windows 21 and 22 can be ascertained using a read unit 23 via a scale applied to the lateral walls of the vessel 1 and the container 20, which are displaced in relation to one another depending on the distance x.

A further embodiment variant of the present invention is shown in FIG. 4, which is also referred to as an immersion probe, for example, because of the principle used. In this embodiment variant, the vessel 1 is arranged inverted, so that the opening 24 of the vessel 1 is immersed first into the liquid medium 3 to be examined. In order that the vessel 1 thus immersed fills with liquid medium 3, air contained in the vessel 1 is discharged in a metered manner by opening the connecting channel 2, whereby the desired fill levels may result in the vessel 1, which are necessary for carrying out absorption measurements as defined in the procedure to be explained hereafter.

If the absorption measurements for a sample are completed, the vessel 1 is in turn emptied by pressing air—for example, from an existing compressed air system, which consists of a pressurized container—through the connecting channel 2 into the vessel 1, whereby the liquid medium 3 is displaced out of the vessel 1 via the opening 24. As soon as the vessel 1 has been completely or nearly completely emptied, a new measuring cycle can be started.

If the connecting channel 2 is arranged spaced apart from the measuring unit 7—as shown in FIG. 4—an air cushion remains in the upper region of the vessel 1 and the liquid medium 3 cannot come into contact with the measuring unit 7, whereby the surface of the measuring unit 7 oriented toward the liquid medium 3 cannot be soiled or can be soiled less.

The method according to the invention will be explained hereafter on the basis of the flow chart illustrated in FIG. 5 with references to the devices according to the invention illustrated in FIGS. 1 to 4.

In a step I, the conveyor device 13 (FIGS. 1 to 3) is instructed by the computer unit 16 to introduce liquid medium 3 at a predefined flow speed into the (empty) vessel 1. In a vessel 1 having constant cross-sectional area and a constant flow speed, the vessel 1 is filled with constant level rise. In the embodiment variant according to FIG. 4, air is accordingly discharged from the vessel 1, so that the desired level rise is obtained. An alternative embodiment variant—also applicable in the variant according to FIG. 4—is that a desired level is obtained by introducing air into the vessel 1. A constant air flow into the vessel 1 results in a reduction of the level in this case.

In a step II, electromagnetic waves 8 having predefined wavelength λ are coupled into the liquid medium 3 contained in the vessel 1, wherein the electromagnetic waves 8 cover a path length in the liquid medium 3 which is dependent on a fill level xᵢ of the liquid medium 3 in the vessel 1. The intensities of the received electromagnetic waves are measured using the measuring unit 7 (FIGS. 1 to 4).

The intensity measurement is repeated at at least one further point in time, i.e., with increased fill level in the vessel. In the flow chart according to FIG. 5, this is indicated by the query of the index i (i=0 . . . n) and by the repetition of step II as long as i<n. Since n is not less than 1, at least two measurements are carried out, wherein these are performed at different fill levels because of the time difference between the measurements.

As soon as the measurements are completed (i.e., i=n), the substance concentration c is or substance concentrations cᵢ are determined using the measured intensities ϕᵢ and the at least two predefined fill levels xᵢ in step III.

Therefore, in step IV, the vessel 1 can in turn be emptied and therefore made ready for a next concentration determination c. It is to be expressly noted that it is not necessary to wait after the last intensity measurement for step IV. In particular, it is not necessary to wait until the concentration determination according to step III is completed. Rather, the emptying of the vessel 1—and therefore step IV—can be begun immediately after the last intensity measurement under step II.

The measurement according to the invention of at least two intensities ϕᵢ at at least two fill levels xᵢ of the vessel 1 has the great advantage that a possible drift of the zero point as a result of soiling—for example, of the cuvette region, through which the electromagnetic waves are coupled into the liquid medium—has no influence on the measurement results and/or on the concentration c to be determined.

The substance concentration—with application of and by derivation of the known law of Lambert, Beer, and Bouguer—can be determined according to the following formula:

$${c}_{i} = \frac{ln {Φ}_{i} ( {x}_{i} ) - ln {Φ}_{i - 1} ( {x}_{i - 1} )}{- 2.302 * ɛ * ( {x}_{i} - {x}_{i - 1} )}$$

wherein cᵢ is the i-th substance concentration, xᵢ is the i-th fill level, Φᵢ(xᵢ) is a measured i-th intensity at a fill level xᵢ, i is the index, which extends in integers from 1 to n, and ε is the coefficient of extinction, and wherein n has a value in the range of 1 to several hundred, preferably a value in the range of 10 to 100.

Accordingly, n intensities Φᵢ are measured at n fill levels xᵢ, wherein the n fill levels xᵢ are preferably selected as equidistant.

The essential advantage in relation to known solutions manifests itself directly in the above formula: The intensity, which is responsible for the zero point, of the magnetic waves originating from the source 4 and coupled into the liquid medium 3 is eliminated by the differentiation according to the invention and/or by the derivation. For this reason, at least two measurements are necessary at different fill levels xᵢ in the vessel.

The point in time tᵢ and/or the fill level xᵢ, at which an intensity Φᵢ(xᵢ) is measured can be produced in different ways: firstly, the option exists of initiating a first measurement by means of time measurement after completion of step IV and performing a further measurement or further measurements in each case after a further time span or after further time spans. Since if the flow speed is known during the filling of the vessel and the shape of the vessel is known, the fill level xᵢ may also be readily determined. Fill level xᵢ and point in time tᵢ are directly related to one another under these conditions and if one variable is known, the other may be readily determined.

If n is selected as greater than 1, multiple values are obtained for the concentration c, namely n values for the concentration, so that an improved result is obtained for the concentration c, for example, by averaging or by means of linear regression, in particular by means of simple linear regression.

The above-explained method may also be determined in a similar manner for determining substances and/or substance proportions in the liquid medium 3. The embodiments in EP-0 600 334 B1 are applied accordingly.

1. A method for determining at least one substance concentration (c) or at least one substance in a liquid medium (3), wherein the method consists of the following steps,
liquid medium (3) is introduced at a predefined flow speed into a vessel (1) having a known shape,
electromagnetic waves having predefined wavelength or having predefined wavelength range are coupled into the liquid medium (3) contained in the vessel (1), wherein the electromagnetic waves (8) cover a path length in the liquid medium which is dependent on a fill level (xᵢ) of the liquid medium (3) in the vessel (1),
intensities (Φᵢ) of the electromagnetic waves are measured after covering the path length in the liquid medium (3) at at least two predefined points in time (tᵢ) and/or at at least two predefined fill levels (xᵢ) of the vessel (1), and
after a last intensity measurement, the at least one substance concentration (c) or the at least one substance is determined using the measured intensities (Φᵢ) and the at least two predefined points in time (tᵢ) or the at least two predefined fill levels (xᵢ), respectively.

2. The method according to claim 1, furthermore comprising the following steps,
n intensities (Φᵢ) are measured at n fill levels (xᵢ), wherein the n fill levels (xᵢ) are preferably selected as equidistant, and
substance concentrations are determined according to the following formula:
$${c}_{i} = \frac{ln {Φ}_{i} ( {x}_{i} ) - ln {Φ}_{i - 1} ( {x}_{i - 1} )}{- 2.302 * ɛ * ( {x}_{i} - {x}_{i - 1} )}$$
wherein cᵢ is the i-th substance concentration, xᵢ is the i-th fill level, Φᵢ(xᵢ) is a measured i-th intensity at a fill level xᵢ, i is the index, which extends in integers from 1 to n, and ε is the coefficient of extinction, and wherein n has a value in the range of 1 to several hundred, preferably a value in the range of 10 to 100.

3. The method according to claim 1, furthermore comprising the following steps,
a first fill level (x₀) is detected, at which a first intensity (Φ₀) is measured,
a last fill level (xₙ) is detected, at which a last intensity (Φₙ) is measured,
wherein the detection of the first level (x₀) and/or the last fill level (xₙ) is preferably performed using a light barrier.

4. The method according to claim 2, furthermore comprising the step that the substance concentration c is computed either by averaging from n substance concentrations cᵢ where i=1 . . . n or by means of linear regression, in particular by means of simple linear regression.

5. The method according to claim 1, wherein the flow speed of the liquid medium (3) is constant.

6. The method according to claim 1, wherein the vessel (1) is a cuvette, the longitudinal axis of which extends essentially vertically, and which has a constant cross-sectional area, wherein the electromagnetic waves are preferably coupled from below into the cuvette and the intensity (Φᵢ) is preferably measured above the cuvette.

7. The method according to claim 1, furthermore comprising the steps that
the vessel (1) is automatically emptied after the last intensity measurement and
after completed emptying, the vessel (1) is automatically filled with new liquid medium (3) for a new measuring cycle.

8. The method according to claim 1, furthermore comprising the step that the fill levels (xᵢ) are ascertained via a time measurement.

9. The method according to claim 1, wherein the electromagnetic waves have a wavelength of 254 nm or 550 nm.

10. A device for determining at least one substance concentration (c) or at least one substance in a liquid medium (3), wherein the device comprises:
a vessel (1) having a known shape,
a source (4) for generating electromagnetic waves (8),
a measuring unit (7) for measuring electromagnetic waves, and a conveyor unit (13) that is connected to the vessel (1) via a connecting channel (2),
characterized in that
the source (4) can emit electromagnetic waves into the vessel (1), so that the electromagnetic waves cover a path length in the liquid medium (3) which is dependent on a fill level (xᵢ) of the liquid medium (3) in the vessel (1),
the measuring unit (7) is adapted for measuring intensities of the electromagnetic waves after covering the path length in the liquid medium (3) at at least two predefined points in time (t₀, tₙ) and/or at at least two predefined fill levels (x₀, xₙ) of the vessel (1), and
a computer unit (16) is operationally connected to the source (4), the measuring unit (7) and the conveyor device (13), the computer unit (16) being adapted for determining of the at least one substance concentration (c) or the at least one substance on the basis of the measured intensities and the at least two predefined points in time (tᵢ) or the at least two predefined fill levels (xᵢ), respectively.

11. The device according to claim 10, characterized in that
n intensities (Φᵢ) are measurable at n fill levels (xᵢ), wherein the n fill levels (xᵢ) are preferably selected as equidistant, and
substance concentrations are determinable in the computer unit (16) according to the following formula:
$${c}_{i} = \frac{ln {Φ}_{i} ( {x}_{i} ) - ln {Φ}_{i - 1} ( {x}_{i - 1} )}{- 2.302 * ɛ * ( {x}_{i} - {x}_{i - 1} )}$$
wherein cᵢ is the i-th substance concentration, xᵢ is the i-th fill level, Φᵢ(xᵢ) is a measured i-th intensity at a fill level xᵢ, i is the index, which extends in integers from 1 to n, and ε is the coefficient of extinction, and wherein n has a value in the range of 1 to several hundred, preferably a value in the range of 10 to 100.

12. The device according to claim 10, characterized in that,
a first fill level (x₀) is detectable, at which a first intensity (Φ₀) is measurable,
a last fill level (xₙ) is detectable, at which a last intensity (Φₙ) is measurable,
wherein preferably a first light barrier (LS1) or a second light barrier (LS2) is respectively provided for detecting the first fill level (x₀) and/or the last fill level (xₙ).

13. The device according to claim 10, characterized in that the substance concentration c is computable in the computer unit (16) either by averaging from the n substance concentrations cᵢ where i=1 . . . n or by means of linear regression, in particular by means of simple linear regression.

14. The device according to claim 10, characterized in that a conveyor device (13) is provided, which is operationally connected to the connecting channel (2), wherein the conveyor device (13) conveys liquid medium (3), preferably at constant flow speed, into the vessel (1).

15. The device according to claim 10, characterized in that the conveyor device (13) for filling and emptying the vessel (1) comprises an automatically actuable switching valve.

16. The device according to claim 10, characterized in that the vessel (1) is a cuvette, the longitudinal axis of which extends essentially vertically, and which has a constant cross-sectional area, wherein the electromagnetic waves are preferably coupled from below into the cuvette (1) and the intensity (Φᵢ) is preferably measured above the cuvette (1).

17. The device according to claim 10, characterized in that the vessel (1) is arranged inverted in the sense of an immersion probe, wherein a fill level (xᵢ) in the vessel (1) is settable by means of air displacement.

18. The device according to claim 10, characterized in that electromagnetic waves having wavelengths of 254 nm and 550 nm can be generated using the source (4).

19. The device according to claim 10, characterized in that a viewing tube (12) has a communicative connection to the vessel (1), via which at least the first fill level (x₀) and the last fill level (xₙ) are determinable.
